(19) United States
(12) Patent Application Publication
(10) Pub. No.: US 2023/0248601 A1
(43) Pub. Date: Aug. 10, 2023

(54) Surgical Table System for Use with Closed-Ring Imaging Device

(71) Applicant: Xoran Technologies, Inc., Ann Arbor, MI (US)

(72) Inventors: William van Kampen, Saline, MI (US); Miodrag Rakic, Saline, MI (US); Daniel Ursu, Ann Arbor, MI (US)

(21) Appl. No.: 18/106,255

(22) Filed: Feb. 6, 2023

Related U.S. Application Data
(60) Provisional application No. 63/306,740, filed on Feb. 4, 2022.

(51) Int. Cl. A61G 13/10

(52) U.S. Cl. CPC A61G 13/105

(57) ABSTRACT

A surgical table system includes components to allow for reconfiguration to enable a closed-ring imaging system to be used with specialized tables. The surgical table system includes a patient support frame comprising first and second side rails and first and second cross rails spanning ends of the first and second side rails; a first end support and a second end support, each of the first and second end supports including an upper portion and a lower portion; and a cross-beam including a first end and a second end, the first end of the cross-beam connected to the lower portion of the first end support, the second end of the cross-beam connected to the lower portion of the second end support through a hinge mechanism. The second end support is removable from the cross-beam at the hinge mechanism.

### CROSS-REFERENCE TO RELATED APPLICATIONS

This application claims the benefit of priority to U.S. Provisional Application No. 63/306,740 filed Feb. 4, 2022, which is hereby incorporated by reference.

### BACKGROUND OF THE INVENTION

The present subject matter relates generally to a patient support tables for surgery. More specifically, the present invention relates to a reconfigurable surgical table system that can accommodate use of a closed-ring imaging device such as a computed tomography (CT) scanner system during surgical procedures.

Certain surgical procedures require the use of a particular surgical table, such as a Jackson table system or an Allen table system, which has a patient support frame system supported at each end by end pillar supports. This style table allows for flexibility in patient positioning that is required for spine surgery in particular.

Intraoperative imaging is desirable both in two dimensional (e.g. x-ray fluoroscopy) and three-dimensional (e.g. x-ray based CT or cone-based CT (CBCT)) modalities. Surgical imaging systems may include “open” structures, such as a C-Arm imaging unit, or “closed” structures, such as Airo® and Loop-X® scanners, each sold by Brainlab AG. For decades, Medtronic Navigation, Inc. has sold an openable CBCT scanner under the trademark O-Arm®. The O-Arm opens its gantry via a gap to get around the table and patient, and then the gap closes to allow a full image acquisition orbit from all angles (see U.S. Pat. No. US8308361B2, the entirety of which is incorporated herein by reference).

The Jackson or Allen tables, however, cannot accommodate the use of closed ring imaging systems. Closed ring imaging systems such as the Airo® and Loop-X® systems require the user of a separate cantilevered table system that changes the patient positioning options and surgical workflow as compared to the Jackson or Allen tables.

Accordingly, there is a need for a reconfigurable Jackson-style surgical table system that can accommodate use of a closed-ring imaging device to allow imaging from all angles, including 360-degree CT/CBCT imaging and x-ray fluoroscopic imaging, during surgery.

### BRIEF SUMMARY OF THE INVENTION

To meet the needs described above and others, the present disclosure provides a surgical table system that can accommodate use of a closed-ring imaging device to allow imaging from all angles, including 360-degree CT/CBCT imaging and x-ray fluoroscopic imaging, during surgery.

By providing a surgical table system that includes components allowing for reconfiguration of the system, the surgical table system can maintain positioning of the patient on the table as the closed-ring imaging device is introduced and positioned about the patient. In other embodiments, the surgical table system is reconfigured prior to surgery such that the patient is positioned on the table after the closed-ring imaging device is positioned about the table.

The surgical table system of the present application includes a patient support frame connected to first and second support ends that can be temporarily reconfigured to allow the gantry of the closed-ring imaging device to be moved around the patient support frame. The surgical table system allows for reconfiguration while the patient is positioned on the patient support frame and/or during the room setup phase prior to positioning the patient on the system.

In some embodiments, a user temporarily removes the second support end to provide access for the closed-ring imaging device. The reconfiguration temporarily disconnects a cross-beam that spans the undersides of the first and second end supports from the second end support. The cross-beam connects to a lower portion of the second end support through a hinge mechanism.

For example, the hinge mechanism may include a pair of wings mounted to the second end support and a wing mounted to the cross-beam. When the cross-beam wing is positioned between the pair of second end support wings, the knuckles of the wings are aligned and receive a pin. The hinge mechanism may include a locking assembly that restricts movement of the knuckles about the pin and/or removal of the pin from the wings.

The surgical table system may include additional support for the patient support table while the second end support is temporarily removed. For example, the surgical table system may include one or more standing braces to maintain the positioning of the patient support table during reconfiguration. Alternatively, the surgical table system may include a support cart to maintain the positioning of the patient support table during reconfiguration.

In other embodiments, the patient support frame may include detachable rail mechanisms that allow portions of the side rails of the patient support frame to be removed so that the closed-ring imaging device can be rolled through openings in the patient support frame and into position for surgery. In these embodiments, a ramp is positioned over the cross-beam to enable the closed-ring imaging device to be rolled over the cross-beam. This surgical table system allows for reconfiguration while the patient is positioned on the patient support frame or during the room setup phase prior to positioning the patient on the system. Alternatively, the ramp may be used with a conventional Jackson or Allen style table to position the closed-ring imaging device about the patient table support during the room setup phase before the patient is on the patient support frame. These embodiments allow the closed-ring imaging device to be introduced with the patient in position on the patient support frame while avoiding the need to remove the second end support.

In light of the disclosure set forth herein, and without limiting the disclosure in any way, in a first aspect, which may be combined with any other aspect or portion thereof described herein, a surgical table system includes a patient support frame comprising first and second side rails and first and second cross rails spanning ends of the first and second side rails; a first end support and a second end support, each of the first and second end supports including an upper portion and a lower portion, and each of the first and second end supports releaseably connected to the first and second cross rails, respectively, of the patient support frame; and a cross-beam including a first end and a second end, the first end of the cross-beam connected to the lower portion of the first end support, the second end of the cross-beam connected to the lower portion of the second end support through a hinge mechanism; wherein the second end support is removable from the cross-beam at the hinge mechanism.

In a second aspect, which may be combined with any other aspect or portion thereof described herein unless otherwise specified, the hinge mechanism includes a pair of support wings secured to the second end support; a cross-beam wing secured to the cross-beam, wherein a knuckle portion of the cross-beam wing is positioned between knuckle portions of the pair of support wings when the pair of support wings and the cross-beam wing are aligned; and a pin positioned through the knuckle portions when aligned.

In a third aspect, which may be combined with any other aspect or portion thereof described herein unless otherwise specified, the surgical table system further comprises a standing brace including a beam including opposing first and second ends; first and second leg portions extending from the beam; and first and second brackets positioned on the first and second ends of the beam, wherein each of the first and second brackets are configured to receive the first and second side rails, respectively, of the patient frame support.

In a fourth aspect, which may be combined with any other aspect or portion thereof described herein unless otherwise specified, each of the first and second brackets includes a clamp to secure the respective first and second side rail of the patient frame support in place.

In a fifth aspect, which may be combined with any other aspect or portion thereof described herein unless otherwise specified, the surgical table system further comprises a support cart including a lower portion including a rectangular frame; an upper portion including first and second support arms, wherein the first and second support arms engage the first and second side rails of the patient support frame; and a vertical portion connecting the lower portion and the upper portion.

In a sixth aspect, which may be combined with any other aspect or portion thereof described herein unless otherwise specified, the patient support frame includes a cross rail connecting the first and second side rails at first and second corners, respectively, and wherein the first and second support arms include first and second outer ends, each of the first and second outer end including a corner connector that receives the first and second corners, respectively, of the patient support frame.

In a seventh aspect, which may be combined with any other aspect or portion thereof described herein unless otherwise specified, each of the first and second outer ends connects to the patient support frame through mechanical, magnetic, or electromagnetic mechanisms.

In an eighth aspect, which may be combined with any other aspect or portion thereof described herein unless otherwise specified, each of the first and second outer ends includes a latching mechanism that engages the cross rail of the patient support frame.

In a ninth aspect, which may be combined with any other aspect or portion thereof described herein unless otherwise specified, a method of introducing a closed-ring imaging device about a patient support frame of a surgical table system is provided. The method includes the step of providing a surgical table system including the patient support frame comprising first and second side rails and first and second cross rails spanning ends of the first and second side rails; a first end support and a second end support, each of the first and second end supports including an upper portion and a lower portion, and each of the first and second end supports releaseably connected to the first and second cross rails, respectively, of the patient support frame; and a cross-beam including a first end and a second end, the first end of the cross-beam connected to the lower portion of the first end support, the second end of the cross-beam connected to the lower portion of the second end support through a hinge mechanism. The method further includes the steps of: supporting the patient support frame using one of a standing brace or a support cart; disconnecting the second end support from the patient support frame; moving the closed-ring imaging device such that the patient support frame extends through the closed-ring; and connecting the second end support to the patient support frame.

In a tenth aspect, which may be combined with any other aspect or portion thereof described herein unless otherwise specified, the standing brace includes a beam including opposing first and second ends; first and second leg portions extending from the beam; and first and second brackets positioned on the first and second ends of the beam, wherein each of the first and second brackets are configured to receive the first and second side rails, respectively, of the patient frame support.

In an eleventh aspect, which may be combined with any other aspect or portion thereof described herein unless otherwise specified, supporting the patient support frame comprises positioning the first and second side rails of the patient support frame in the first and second brackets, respectively, of the standing brace. In a twelfth aspect, which may be combined with any other aspect or portion thereof described herein unless otherwise specified, support cart includes: a lower portion including a rectangular frame; an upper portion including first and second support arms, wherein the first and second support arms engage the first and second side rails of the patient support frame; and a vertical portion connecting the lower portion and the upper portion.

In a thirteenth aspect, which may be combined with any other aspect or portion thereof described herein unless otherwise specified, the patient support frame includes a cross rail connecting the first and second side rails at first and second corners, respectively, and wherein the first and second support arms include first and second outer ends, each of the first and second outer end including a corner connector.

In a fourteenth aspect, which may be combined with any other aspect or portion thereof described herein unless otherwise specified, supporting the patient support frame comprises positioning the first and second corners of the patient support frame atop the corner connectors of the first and second outer ends of the first and second support arms of the support cart.

An object of the invention is to provide a solution that enables imaging of all angles including 360-degree CT/CBCT acquisition as well as x-ray fluoroscopic imaging during surgery requiring a Jackson or Allen style surgical table.

Another object of the invention is to provide a solution to introduce the gantry of the imaging device about the patient table before surgery begins as well as after the patient is positioned on the patient table.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of a conventional surgical table of the prior art.

FIG. 2 is a perspective view of an embodiment of a surgical table of the present application configured for use with a closed-loop imaging device utilizing an removable end support and a standing brace.

FIG. 3 is a perspective view of the surgical table of FIG. 2 with the removable end support in a support position and showing the brackets, and FIG. 3A is an enlarged view of the brackets.

FIG. 4 is a perspective view of the surgical table of FIG. 2 with the removable end support in a disengaged position and showing the brackets thereof, and FIG. 4A is an enlarged view of the brackets.

FIG. 5 is a perspective view of the standing brace shown in FIG. 2, and FIG. 5A is an enlarged view of a bracket of the standing brace.

FIGS. 6A and 6B are perspective views of the surgical table of FIG. 2 utilizing the removable end support and an extension cart, showing the closed-loop imaging device at different positions.

FIGS. 7A-7C are elevational views of an inner surface of an latching arm of the cart of FIGS. 6A and 6B.

FIG. 8 is a perspective view of the surgical table of FIG. 2 utilizing detachable rail mechanisms and a ramp.

FIGS. 9A-9C are partial, perspective views of a first embodiment of a detachable rail mechanism shown in a disconnected position, a mating position, and a locked position, respectively.

FIGS. 10A-10C are perspective view of a second embodiment of a detachable rail mechanism shown in a locked position, a mating position, and a disconnected position, respectively.

FIG. 11 illustrates a first embodiment of a ramp configured for use with a surgical table of FIG. 8.

FIG. 12 illustrates a second embodiment of a ramp configured for use with a surgical table of FIG. 8.

### DETAILED DESCRIPTION OF THE INVENTION

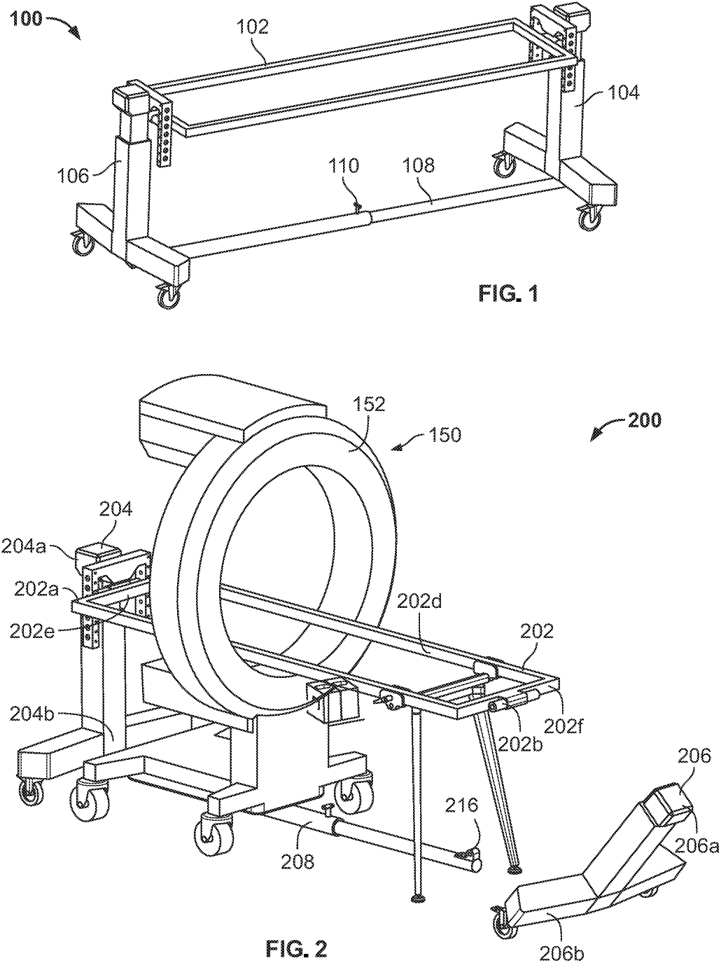

FIG. 1 illustrates a conventional surgical table 100 with components common to Jackson or Allen tables. The surgical table 100 includes a patient support frame 102 to support the patient body that is secured to head and foot end supports 104, 106. The patient support frame 102 is connected to each end support 104, 106 via a bracket and locking pins, which can be removed during normal table setup and use. The patient support frame 102 may be constructed of radiolucent rails. Each of the head and foot end supports 104, 106 telescope vertically to adjust the heights thereof and are mounted onto casters to allow the table 100 to easily move within the surgical room.

A cross-beam 108 mounted to the undersides of the head and foot end supports 104, 106 includes inner and outer telescoping tubes to adjust a length of the table 100. A knob, turn screw, or other tightening device 110 may be provided at an overlap of the inner and outer tubes of the cross-beam 108 to prevent further extension or contraction. Within the cross-beam 108, an electrical cable carries power from the head end support, which contains an embedded power supply, to the foot end support.

FIGS. 2-12 illustrate example surgical table systems 200, 300 of the present application. Each surgical table system 200 includes a patient support frame 202 secured to upper portions 204a-1, 206a-1 of first and second end supports 204, 206 at the first and second ends 202a, 202b of the patient support frame 202, respectively. The patient support frame 202 includes first and second side rails 202c, 202d and first and second cross rails 202e, 202f spanning ends of the first and second side rails. A cross-beam 208 spans lower portions 204a-2, 204b-2 of the first and second end supports 204a, 204b, similar to the conventional surgical table 100 shown in FIG. 1.

The surgical table systems 200, 300 described herein include a number of components that enable reconfiguration of the table in order to position the closed-ring scanner 150 about the patient support frame 202 during surgery. For example, the surgical table system 200 shown in FIGS. 2-7C allows for reconfiguration and introduction of the closed-ring imaging device 150 about the patient support frame 202 while the patient is positioned on the surgical table system 200 ready for surgery, although the imaging device 150 alternatively may be positioned about the patient support frame 202 during the room setup phase before the patient is on the support table system 200. The surgical table system 300 shown in FIGS. 8-12 allows for reconfiguration and introduction of the closed-ring imaging device 150 about the patient support frame 302 before the patient is on the support table system 300 during the room setup phase. Additionally, while each component is described with respect to a specific embodiment, it is noted that components from various embodiments may be combined into a surgical table system as needed.

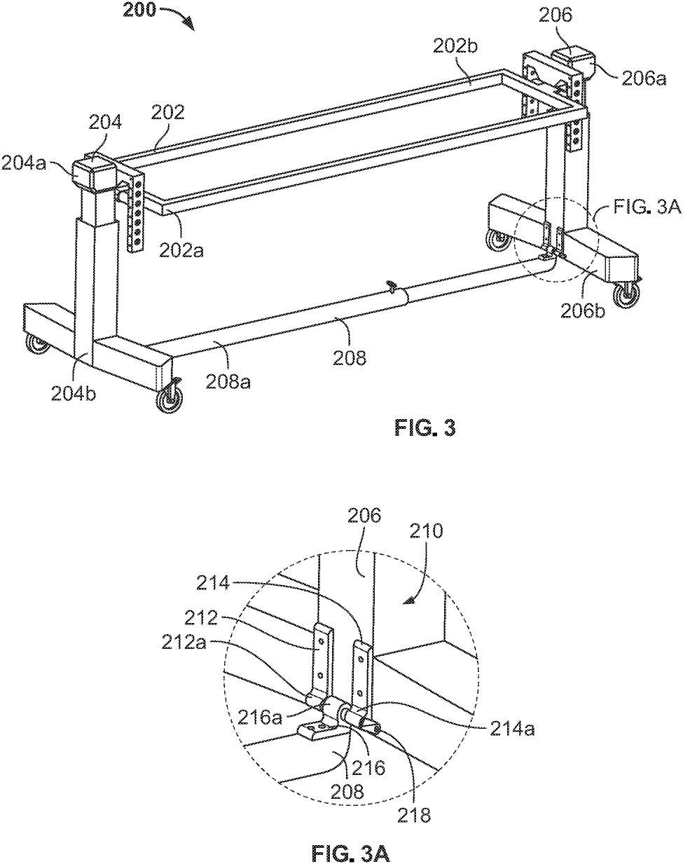

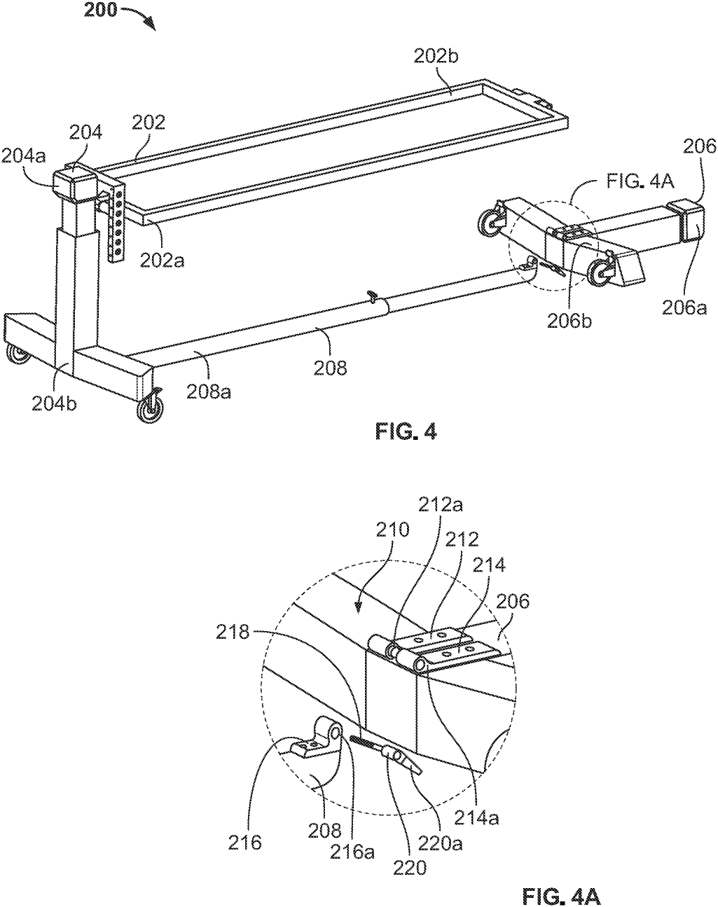

Referring to FIG. 2, in contrast to the conventional surgical table 100, the cross-beam of the surgical table system 200 is connected to the second end support through one or more hinge mechanisms 210 (FIGS. 3A and 4A) to enable the second end support 206 to move from an upright support position (FIG. 3) to a horizontal disengaged position (FIG. 4) or removed altogether. By disconnecting the second end support 206 from the patient support frame 20 and moving it downwardly and/or away, the second end 202b of the patient support frame 202 is free to move through the gantry of the closed-ring CT scanner, allowing the scanner to be introduced about the patient supporting frame.

FIGS. 3A and 4A show an example hinge mechanism 210 including a pair of end support wings 212, 214 and a cross-beam wing 216 connected by a pin 218. The end support wings 212, 214 are secured to an inner surface of the second end support 206 and the cross-beam wing 216 is secured to an upper surface of the cross-beam 208. When a knuckle portion 216a of the cross-beam wing 216 is positioned between knuckle portions 212a, 214a of the pair of end support wings 212, 214, the pin 218 is inserted through the aligned knuckle portions 212a, 216a, 214a to connect the cross-beam 208 to the second end support 206.

The hinge mechanism 210 may include a locking mechanism 220 (FIG. 4A) to allow or prevent hinge rotation and/or release of the pin 218 from the hinge wings 212, 216, 214. For example, the locking mechanism 220 may include a locking lever 220a that, when locked, restricts movement of the knuckles 212a, 214a, 216a about the pin 218. Compression of the locking lever 220a releases the knuckles 212a, 214a, 216a from the restriction, allowing the knuckles 212a, 214a, 216a to rotate about the pin 218 and move the upper portion 206a of the second end support 206 away from the patient support frame 202 to move the end support 206 into a horizontal position (FIG. 4). The pin 218 may also be removed altogether from the knuckles 212a, 214a, 216a in order to separate the lower portion 206b of the end support 206 from the cross-beam 208.

In another embodiment, the locking mechanism 220 may include a protrusion extending from the pin and an internal groove on an inside of the aligned knuckles, with the pin being removable from the knuckles only when the protrusion is aligned with the groove. When the pin is twisted so that the protrusion is not aligned with the groove, the pin cannot be removed. In another example, the locking mechanism 220 may include a key or a knob that mates with the pin such that the pin can only be removed through use of the key or knob.

FIG. 3 illustrates the end support 206 in the upright support position to support the patient frame 202. As seen in FIG. 3A, the pin 218 is threaded through the knuckles 212a, 214a, 216a of the hinge mechanism 210 when the end support 206 is in the support position. To move the end support 206 into the disengaged position (FIG. 4), the patient support frame 202 is disconnected from the upper portion 206a of the second end support 206, allowing the second end support 206 to rotate about the hinge mechanism 210. The pin 218 may be removed from the knuckles 212a, 214a, 216a as shown in FIG. 4A to allow the end support 206 to detach from the second end of the cross-beam 208.

To allow unrestricted displacement of the end support 206 from the rest of the surgical table system 200, the cable running through the cross-beam 208 may be spliced, with each end support 204, 206 provided with socket connectors to maintain communication when the end support 206 is moved out of the support position. For example, the socket connectors may be uncoupled during normal use, and become coupled when the end support is removed or aligned back into its original position at the end of the surgical table.

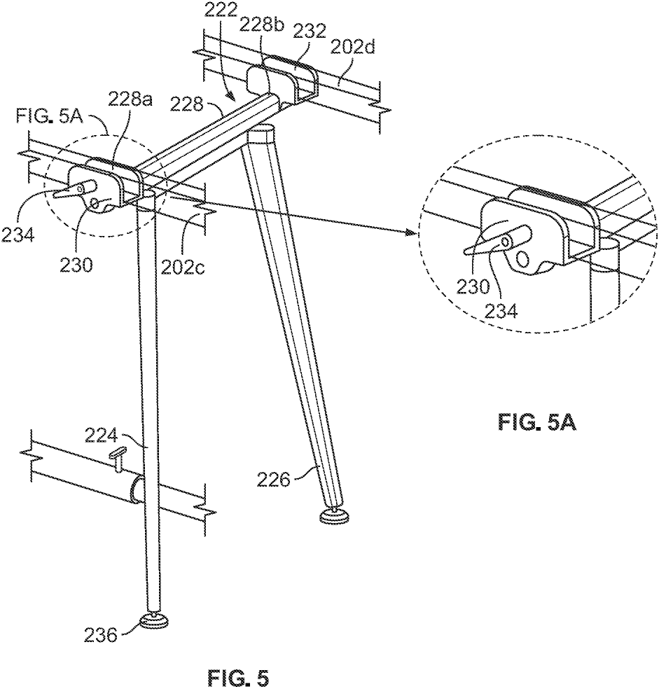

Referring to FIGS. 5 and 5A, the support table system 200 may also include a standing brace 222 to temporarily support the patient support frame 202 during reconfiguration. For example, the standing brace 222 may be positioned on the patient support frame 202 near the second end support 206 so that the patient support frame 208, and patient positioned thereon, is supported as the second end support 206 is removed and the closed-ring imaging device 180 is moved into position about the patient support frame 202.

In the illustrated embodiment, the standing brace 222 includes first and second legs 224, 226 connected to a lateral beam 228. Outer ends 228a, 228b of the beam 228 include first and second brackets 230, 232, respectively, that receive the rails 202c, 202d of the frame 202. In some embodiments, a clasp 234 secures each rail 202c, 202d within the respective bracket 230, 232 to fix the rail 202c, 202d in place. The first and second legs 224, 226 angle outwardly from the lateral beam 228 and include swivel end caps 236. In other embodiments, the standing brace 222 may include more than two legs, each leg may include addition support structures, or legs including telescoping tubes to allow for easy adjustment in height. Other variations may be included.

In one method of reconfiguration, a standing brace 222 is positioned on the patient support frame 202 at a distance from the second end 202b thereof so that the closed-ring CT scanner 150 can be moved into position between the standing brace 222 and the second end support 206. Once the standing brace 222 is set, the second end support 206 is disconnected from the patient support frame 202 and moved into the disengaged position or detached. The gantry 152 of the closed-ring CT scanner 150 is then introduced at the second end 202b of the frame 202 and, once the CT scanner 150 clears the second end 202b of the frame 202 as shown in FIG. 2, the standing brace 222 may be moved from its initial position between the first end 202a of the patient support frame 202 and the closed-ring imaging device 150 to a position near the second end 202b of the patient support frame 202 as the second support end 206 is returned to the support position (FIG. 4). The positioning of the standing brace 222 is carefully chosen to avoid inconvenience to the patient, surgeon, surgical team, or other equipment. Once the closed-ring imaging device 150 is no longer needed, the standing brace 222 is used as described above to support the patient support frame 202 as the second end support 206 is again disconnected therefrom and reattached after the imaging device 150 is removed.

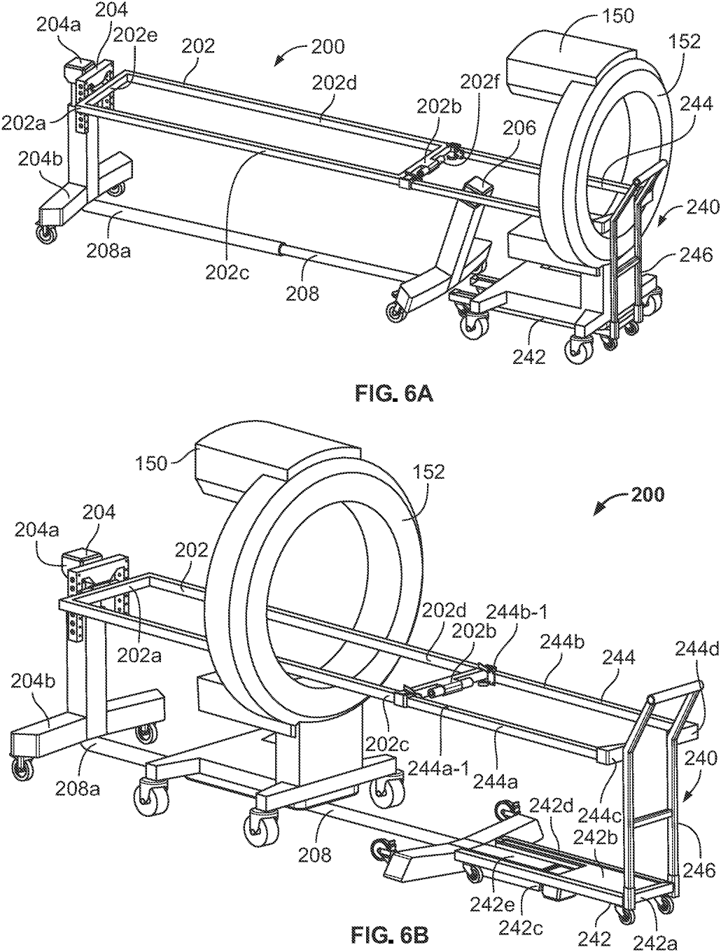

Referring to FIGS. 6A and 6B, the support table system 200 may include a support cart 240 to support the frame 202 temporarily while the second end support 206 is disconnected from the patient support frame 202 and reattached. The support cart 240 is sized to receive and fit around the closed-ring CT scanner 150 as shown in FIG. 6A. Once the support cart 240 is secured to the patient support frame 202, the second end support 206 can be removed, the CT scanner 150 can be moved to a position about the frame 202 as shown in FIG. 6B, the second end support 206 can then be reattached, and the support cart 240 can be removed.

The support cart 240 includes parallel upper and lower horizontal portions 242, 244 spaced apart by a vertical portion 246 at a first cart end 240a. At a second cart end 240b opposite the first cart end 240a, the upper and lower portions 242, 244 remain spaced apart from one another in order to receive the closed-ring imaging device 150. The lower portion 242 is sized to fit under the CT scanner 150 and the upper portion 244 is sized to extend through the closed-ring loop or gantry 152 of the CT scanner 150 as shown in FIG. 6A.

In the embodiment illustrated in FIG. 6B, the lower portion 242 includes a rectangular frame 242a with a planar surface 242b spanning first and second sides 242c, 242d. The planar surface 242b includes an opening 242e near the second cart end 240b to accommodate the removal or lowering of the second end portion 206. To fit under the CT scanner 150, the first and second sides 242c, 242d have a width that is less than a width between adjacent wheels on the CT scanner 150 and a height of the lower portion 242 above the ground is less than a height of the underside of the CT scanner 150 above the ground so that the lower portion 242 fits under the CT scanner 150. Wheels are provided on the underside of the lower portion 242 to allow for movement of the support cart in the surgical room.

In the illustrated embodiment, the vertical portion includes parallel tubing or rails and a gripping portion extending outwardly therefrom. In other embodiments, a planar surface or other configuration may be provided.

The upper portion 244 of the support cart 240 includes first and second support arms 244a, 244b that align with the first and second rails 202c, 202d of the patient support frame 202. In the illustrated embodiment, the first and second support arms 244a, 244b are parallel and are connected to the vertical portion 246 by first and second connectors 244c, 244d, respectively, at the first cart end 240a, as the width of the first and second support arms 244a, 244b is greater than the width of the vertical portion 246. In other embodiments, the first and second support arms 244a, 244b angle outwardly directly from the vertical portion 246 such that a width of outer ends of the first and second support arms 244a, 244b align with the first and second rails 202c, 202d of the patient support frame 202.

At the second cart end 240b, each outer end 244a-1, 244b-1 of the first and second support arms 244a, 244b engage with and support the first and second rails 202c, 202d and the second cross rail 202f spanning the first and second rails 202c, 202d of the patient support frame 202. The support arms 244a, 244b may connect to the patient support frame 202 through mechanical, magnetic, or electromagnetic mechanisms.

Specifically, the cross rail 202 forms first and second corners 202a, 202b with the first and second rails 202c, 202d, respectively. At each outer end 244a-1, 244b-1 of the first and second support arms 244a, 244b of the support cart 240, a corner connector or bracket 248 is provided to receive and support the respective corner 202a, 202b of the patient support frame 202. On an inner surface of each outer end of the support arms 244a-1, 244b-1, a latching mechanism 250 is connected thereto to capture and maintain grip on the cross rail 202f of the patient support frame 202.

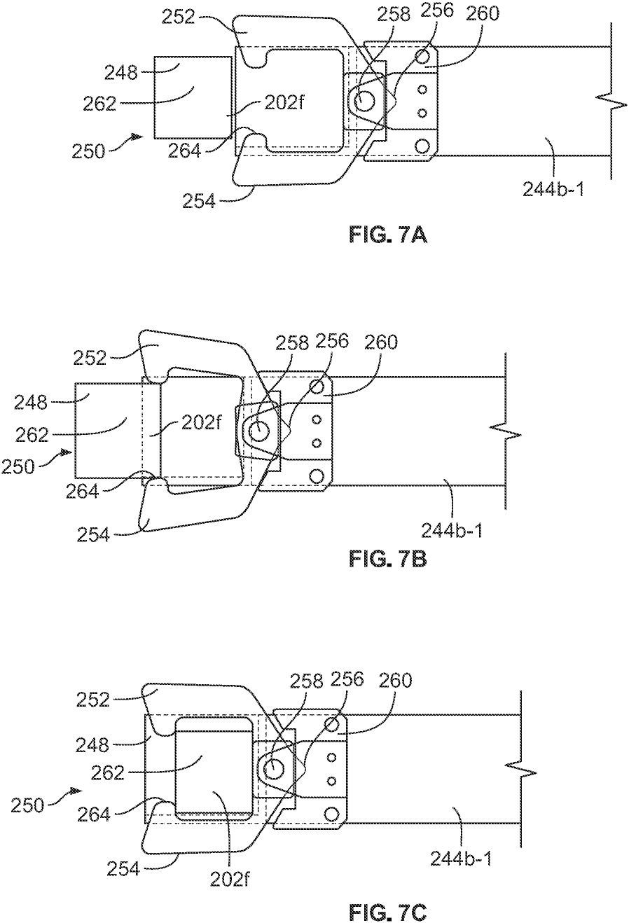

Latching of the latching mechanism 250 is shown in FIGS. 7A-7C. First and second levers 252, 254 are biased together by a torsional spring 256 at a pivot point 258 on a mounting plate 260. In a resting position shown in FIG. 7A, inner surfaces of the levers 252, 254 define an inner containment space 262 sized to fit the cross rail 202f of the patient support frame 202. Outer ends 252a, 254a of the levers 252, 254 are spaced apart to define an access opening 264 to the inner containment space 262, the access opening 264 being smaller than a height of the cross rail 202f. The outer ends 252a, 254a of the levers 252, 254 are angled inwardly from an external perspective so that pressure on the angled outer ends 252a, 254a by the cross rail 202f due to movement of the latching mechanism 250 toward the patient support frame 202 applies force against the torsional spring 256 and causes the levers 252, 254 to rotate about the pivot point 258, opening the levers 252, 254 to allow the patient support frame 202 into the inner containment space 262 as shown in FIG. 7B. Once the cross rail 202f is inside the containment space 262 as shown in FIG. 7C, the cross rail 202f has cleared the access opening 264 and the levers 252, 254 return to the resting position.

Once the first and second support arms 244a, 244b are attached to the patient support frame 202, the second end support 206 can be removed or moved into the disengaged position. The cross-beam 208 may be adjusted to make space for the second end support 206 to be reconfigured. The CT scanner 150 is then moved past the second end 202b of the patient support frame 202 and introduced around the patient on the patient support frame 202 as shown in FIG. 6B. The second end support 206 is then repositioned to the support position and the support cart 240 can be disconnected from the patient support frame 202. The support cart 240 can be used in the same way described above to remove the closed-ring CT scanner 150 from around the frame 202.

In the embodiments shown in FIGS. 8-12, the support table system 300 includes a patient support frame 302 including detachable rail mechanisms 340, 370 and a ramp 380, 390 that enables the closed-ring imaging device 150 to be moved into position about the patient support frame 302 either while the patient is positioned on the patient support frame 302 or during the room setup phase prior to positioning the patient on the system 300. Alternatively, the ramp 360, 370 may be used with a conventional Jackson or Allen style table 100 to position the closed-ring imaging device 150 about the patient table support 102 during the room setup phase before the patient is on the patient support frame 102. These embodiments allow the closed-ring imaging device 150 to be introduced with the patient in position on the patient support frame 102, 302 while avoiding the need to remove the second end support 306. The support table system 300 includes many of the same components described above with respect to support table system 200, which are shown with like numbers that do not need to be re-described.

Referring to FIG. 8, each of the first and second rails 302c, 302d of the patient support frame 302 includes a removable rail portion 302c-1, 302d-1 connected to the remaining main rail 302c-2, 302d-2 by a pair of detachable rail mechanisms 340. The pair of detachable rail mechanisms 340 allows the removable rail portion 302b-1 to be disconnected from the main rail 302b-2 so that gaps are created between the main rails 302b-2 of the first and second rails 302c. 602d and the second end support 306. The closed-ring imaging device 150 can be rolled through the gaps in order to position it about the patient support frame 302. Once the imaging device 150 is in position, the removable rail portions 302c-1, 302d-1 can be reconnected.

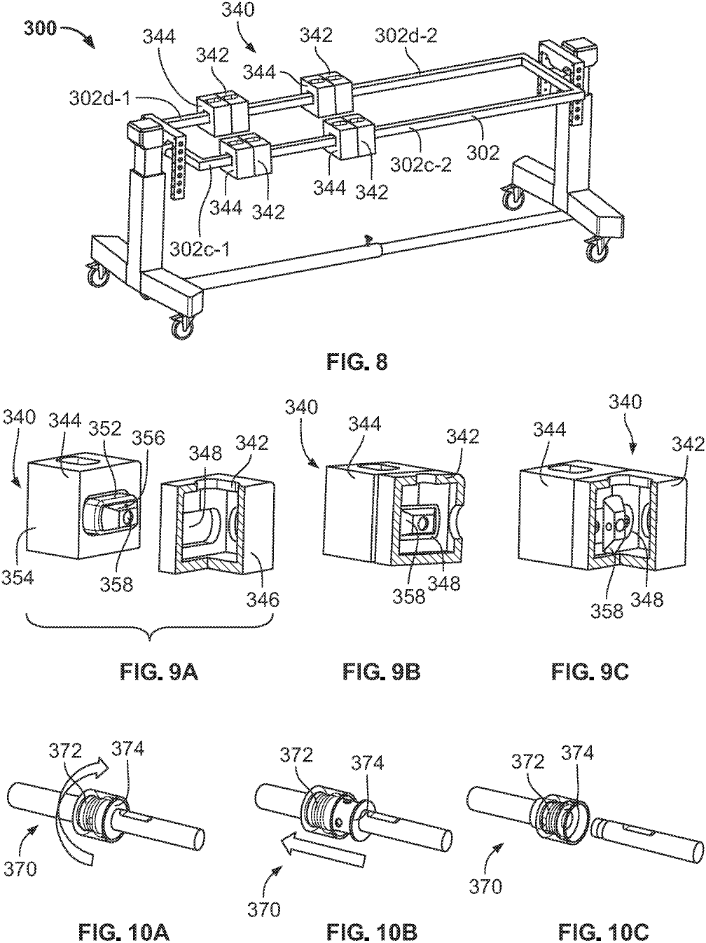

A first embodiment the detachable rail mechanism 340 is shown in FIGS. 8 and 9A-9C. Referring to FIGS. 9A-9C, each detachable rail mechanism 340 includes a main rail connector 342 secured to the main rail portion 302c-2, 302d-2 that engages with a removable rail connector 344 secured to the removable rail portion 302c-1, 302d-1. As shown in FIG. 8, each removable rail portion 302c-1, 302d-1 is provided with removable rail connectors 344 at each end thereof. The main rail connector 342 and the removable rail connector 344 can be secured to the first and second rails 302c, 302d through attachment mechanisms such as brackets and locking pins, locking pin and corresponding extrusions, clamps, clasps, and other suitable means.

Each main rail connector 342 includes a housing 346 with a rectangular opening 348 on a surface facing the removable rail connector 344. Each removable rail connector 344 includes a rotatable base 352 connected to a housing 354 facing the main rail connector 342. The rotatable base 352 has an outer shape that corresponds to the rectangular opening 348 of the main rail connector 342. A locking member 356 is positioned on the rotatable base 352 and is secured to the housing 354 of the removable rail connector 344 via a pin 358 so that the locking member 356 remains stationary relative to the housing 354 while the rotatable base 352 rotates about the pin 358. The locking member 356 has a shape that is equal to or smaller than the shape of the rotatable base 352, and the locking member 356 and rotatable base 352 shapes are provided such that the shapes can move out of alignment with one another. For example, when the locking member 356 moves between an aligned or unlocked position as shown in FIG. 9A and an unaligned or locked position shown in FIG. 9C. The removable rail portion 302c-1, 302d-1 may include spring loaded, telescoping tubes so that a length of the removable rail portion 302c-1, 302d-1 can be shortened as needed, as described below.

To connect the main rail connector 342 and the removable rail connector 344, the locking member 356 and the rotatable base 352 are aligned and inserted through the opening 348 on the housing 346 of the main rail connector 342. The removable rail portion 302c-1, 302d-1, onto which the housing 354 of the removable rail connector 344 is attached, is rotated relative to the main rail connector 342 such that the locking member 358 moves into the locked position while the rotatable member 352 remains in position in the opening 348 of the main rail connector 342.

To connect the removable rail portion 302c-1, 302d-1 to the patient support frame 302, the locking members 356 of the removable rail connectors 344 at the ends of the removable rail portion 302c-1, 302d-1 are positioned in the unlocked position such that the shapes of the locking members and the respective rotatable bases are aligned. The locking members 356 are then inserted into the openings 348 of the main rail connectors 346 and the removable rail connector 344 is then rotated to move the locking members 358 into the locked positions.

To disconnect the removable rail portion 302c-1, 302d-1 from the patient support frame 302, removable rail connector 344 is rotated to move into the locking members 356 from the locked positions into unlocked positions. The length of the removable rail portion 302c-1, 302d-1 is shortened by applying force against the bias of the spring-loaded tubing to enable the locking members 356 to be withdrawn from the opening 348 of the respective main rail connector 342.

FIGS. 10A-10C illustrate an alternative embodiment detachable rail mechanism 370. In this embodiment, the detachable rail mechanism 370 includes a rotatable tightener 372 that receives a gripping member 374. The gripping member 374 grips the removable rail portion 302c-1, 302d-1 that is inserted into an opening in the gripping member 374. By rotating the tightener 372, a force applied around the gripping member 374 to secure the removable rail portion 302c-1, 302d-1 in place. To release the removable rail portion 302c-1, 302d-1, the rotatable tightener 372 is rotated about the gripping member 374 in the reverse direction as shown in FIG. 10A and slid away from the removable rail portion 302c-1, 302d-1 as shown in FIG. 10B, allowing the removable rail portion 302c-1, 302d-1 to be released from the gripping member 374 as shown in FIG. 10C. Similar to the embodiment shown in FIGS. 8 and 9A-9C, each end of the removable rail portion 302c-1, 302d-1 connects to the main rail 302c-2, 302d-2 through a pair of detachable rail mechanisms 370.

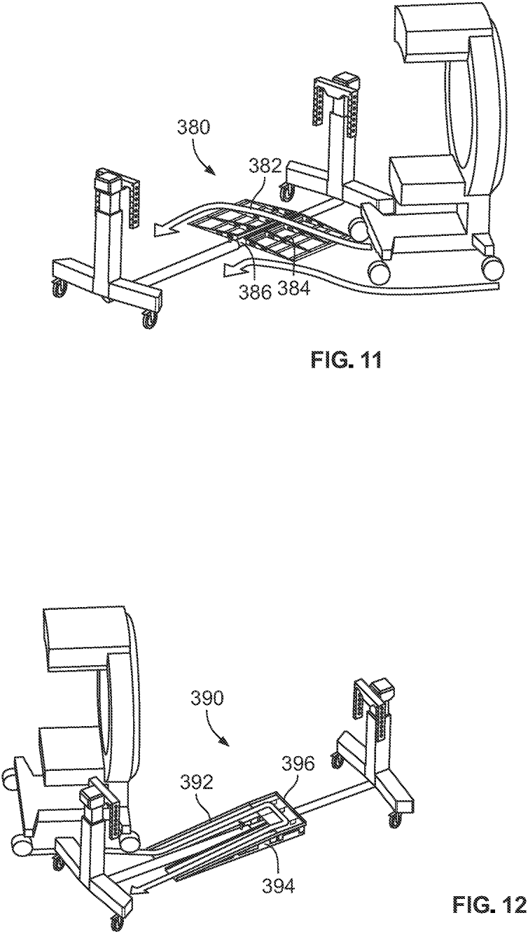

FIG. 11 illustrates a ramp 380 including first and second side portions 382, 384 that are mirror images of one another. Each side portion 382, 384 includes a center side and an outer side and has a height that tapers from the center side edge to the outer side edge. The center side includes an upper center edge that overhangs a lower center edge to create a notched portion 386. The notched portions 386 of the center sides of the side portions 382, 384 are positioned side-by-side about the cross-bar to provide the ramp 380 as shown in FIG. 11. In some embodiments, an upper surface spans the upper center edge and the outer side while a lower surface spans the lower center edge and the outer side, and an internal support structure including lateral and longitudinal beams support the upper surface and the imaging device moving across during use. In other embodiments, an upper surface spans the upper center edge and the outer side while a support structure spans the lower center edge and the outer side.

FIG. 12 illustrates an alternative embodiment ramp 390 that includes first and second ramp portions 392, 394 and a connecting elevated surface 396. Each of the first and second ramp portions 392, 394 includes a ground edge and an elevated edge and has a height that tapers from the elevated edge to the ground edge. A ramp surface spans the elevated edge and the ground edge and is supported by support structures such as a plurality of fins and optional cross beams. The connecting elevated surface 396 is also supported by support structures such as a plurality of fins, and has a width sized to receive the front pair of wheels of the closed-ring CT scanner 150. The first and second ramp portions 392, 394 and the connecting elevated surface 396 may be interconnected through slots and locking pins along interfacing surfaces. In some embodiments, the first and second ramp portions 392, 394 and the connecting elevated surface 396 includes raised edges or rims along outer edges thereof in order to guide the wheels of the closed-ring CT scanner along a prescribed path and prevent roll-off.

During use, the connecting elevated surface 396 is positioned over the cross-beam 308 such that the cross-beam 308 fits between a pair of adjacent fins. The first and second ramp portions 392, 394 are positioned on each side of the cross-beam 308, spaced to receive a pair of wheels of the closed-ring CT scanner 150, and then positioned and/or connected to the connecting elevated surface. During use, wheels along one side of the CT scanner 150 are wheeled up a first ramp portion 392, across the connection portion 396, and down the second ramp portion 394.

If the table support system 300 being used includes the disconnecting rail mechanisms 340, 370, the CT scanner 150 is rolled into position about the patient support frame 302 and the removable rail portions 302c-1, 302d-1 are returned to position within the patient support frame 302. If the patient support frame 302 was removed prior to using the ramp, the patient support frame 302 is passed through the gantry of the closed-ring CT scanner 150 and attached to the first and second end supports 304, 306. The ramp 380, 390 can then be removed during surgery if needed.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A surgical table system comprising:
a patient support frame comprising first and second side rails and first and second cross rails spanning ends of the first and second side rails;
a first end support and a second end support, each of the first and second end supports including an upper portion and a lower portion, and each of the first and second end supports releaseably connected to the first and second cross rails, respectively, of the patient support frame; and
a cross-beam including a first end and a second end, the first end of the cross-beam connected to the lower portion of the first end support, the second end of the cross-beam connected to the lower portion of the second end support through a hinge mechanism;
wherein the second end support is removable from the cross-beam at the hinge mechanism.

2. The surgical table system of claim 1, wherein the hinge mechanism comprises:
a pair of support wings secured to the second end support;
a cross-beam wing secured to the cross-beam, wherein a knuckle portion of the cross-beam wing is positioned between knuckle portions of the pair of support wings when the pair of support wings and the cross-beam wing are aligned; and
a pin positioned through the knuckle portions when aligned.

3. The surgical table system of claim 1, further comprising a standing brace including:
a beam including opposing first and second ends;
first and second leg portions extending from the beam; and
first and second brackets positioned on the first and second ends of the beam, wherein each of the first and second brackets are configured to receive the first and second side rails, respectively, of the patient frame support.

4. The surgical table system of claim 3, wherein each of the first and second brackets includes a clamp to secure the respective first and second side rail of the patient frame support in place.

5. The surgical table system of claim 1, further comprising a support cart including:
a lower portion including a rectangular frame;
an upper portion including first and second support arms, wherein the first and second support arms engage the first and second side rails of the patient support frame; and
a vertical portion connecting the lower portion and the upper portion.

6. The surgical table system of claim 5, wherein the patient support frame includes a cross rail connecting the first and second side rails at first and second corners, respectively, and wherein the first and second support arms include first and second outer ends, each of the first and second outer end including a corner connector that receives the first and second corners, respectively, of the patient support frame.

7. The surgical table of claim 6, wherein each of the first and second outer ends connects to the patient support frame through mechanical, magnetic, or electromagnetic mechanisms.

8. The surgical table of claim 6, wherein each of the first and second outer ends includes a latching mechanism that engages the cross rail of the patient support frame.

9. A method of introducing a closed-ring imaging device about a patient support frame of a surgical table system, the method comprising:
providing a surgical table system including:
the patient support frame comprising first and second side rails and first and second cross rails spanning ends of the first and second side rails;
a first end support and a second end support, each of the first and second end supports including an upper portion and a lower portion, and each of the first and second end supports releaseably connected to the first and second cross rails, respectively, of the patient support frame;
a cross-beam including a first end and a second end, the first end of the cross-beam connected to the lower portion of the first end support, the second end of the cross-beam connected to the lower portion of the second end support through a hinge mechanism;
supporting the patient support frame using one of a standing brace or a support cart;
disconnecting the second end support from the patient support frame;
moving the closed-ring imaging device such that the patient support frame extends through the closed-ring; and
connecting the second end support to the patient support frame.

10. The method of claim 9, the standing brace comprises:
a beam including opposing first and second ends;
first and second leg portions extending from the beam; and
first and second brackets positioned on the first and second ends of the beam, wherein each of the first and second brackets are configured to receive the first and second side rails, respectively, of the patient frame support.

11. The method of claim 10, wherein supporting the patient support frame comprises positioning the first and second side rails of the patient support frame in the first and second brackets, respectively, of the standing brace.

12. The method of claim 10, wherein the support cart includes:
a lower portion including a rectangular frame;
an upper portion including first and second support arms, wherein the first and second support arms engage the first and second side rails of the patient support frame; and
a vertical portion connecting the lower portion and the upper portion.

13. The method of claim 12, wherein the patient support frame includes a cross rail connecting the first and second side rails at first and second corners, respectively, and wherein the first and second support arms include first and second outer ends, each of the first and second outer end including a corner connector.

14. The method of claim 13, wherein supporting the patient support frame comprises positioning the first and second corners of the patient support frame atop the corner connectors of the first and second outer ends of the first and second support arms of the support cart.

15. The method of claim 14, wherein each of the first and second outer ends of the first and second support arms of the support cart includes a latching mechanism that engages the cross rail of the patient support frame.
